(19) United States
(12) Patent Application Publication
(10) Pub. No.: US 2010/0289827 A1
(43) Pub. Date: Nov. 18, 2010

(54) Single-Gamma Based Color Gamma Generation System and Method and Display System thereof

(76) Inventor: Shing-Chia Chen, Tainan (TW)

Correspondence Address: STOUT, UXA, BUYAN & MULLINS LLP, 4 VENTURE, SUITE 300, IRVINE, CA, 92618, US

(21) Appl. No.: 12/464,815

(22) Filed: May 12, 2009

(51) Int. Cl. G09G 5/10

(52) U.S. Cl. 345/690

(57) ABSTRACT

A single-gamma based color gamma generation system and method is disclosed. In one embodiment, a gamma controller generates a number of gamma curves associated with a number of colors respectively in a color space. A gamma reference voltage generator (GRVG) generates a plurality of gamma reference voltages according to one selected gamma curve associated with a selected color. An image processor receives the gamma curves and compensates the image data of non-selected color or colors.

### BACKGROUND OF THE INVENTION

1. Field of the Invention

The present invention generally relates to gamma generation, and more particularly to a single-gamma based color gamma generation system and method.

2. Description of the Prior Art

Most display systems possess a nonlinear relationship known as the gamma response characteristic, in which a given display system does not display brightness in a way that is perfectly proportional to the input voltage. Because of the gamma property, image signals are usually pre-compensated by a gamma curve to inversely compensate for the nonlinearities of the display system.

A flat panel display, such as a liquid crystal display (LCD), typically includes a gamma reference voltage generator (GRVG) for correcting the non-linear perception of human eyes. FIG. 1A shows a conventional GRVG which uses a voltage divider made of serially connected resistors 10. In order to enhance contrast in modern flat panel displays, the reference voltages generated by the GRVG are dynamically adjusted according to data distribution. FIG. 1B shows an exemplary adaptive (or dynamic) analog GRVG 12 such as disclosed in “Contrast Enhancement in Liquid Crystal Displays by Adaptive Modification of Analog Gamma Reference Voltages” by Seung-Woo Lee, IEICE Trans. Electron., Vol. E90-C, No. 11, pp. 2083-2087, November 2007, the disclosure of which is hereby incorporated by reference.

The adaptive (or dynamic) GRVG, such as that disclosed in FIG. 1B, is at best adaptable to gray display. For color display, independent gamma (or three-gamma) architecture is required, as disclosed in “A Third Generation Timing Controller And Column Driver Architecture Using Point-to-Point Differential Signaling” by R. I. McCartney and M. J. Bell, J. Society for Information Display, Vol. 13, No. 2, pp. 91-97, February 2005, the disclosure of which is hereby incorporated by reference.

FIG. 2A shows a block diagram of the three-gamma timing controller (TCON), and FIG. 2B shows exemplary three independent gamma voltage curves. Referring to FIG. 2A, the three-gamma TCON includes a dynamic analog gamma controller 20, which provides gray code to the three independent GRVGs 22R, 22G and 22B respectively. According to this architecture, the three GRVGs 22R, 22G and 22B not only occupy substantive chip area, but also are unadaptable to the architecture of TCON nowadays.

For the reason that conventional three-gamma architectures are complicated in either architecture or manufacture, a need has arisen to propose a novel color dynamic analog gamma system that is simple in architecture and compatible with existing timing controllers (TCONs).

### SUMMARY OF THE INVENTION

In view of the foregoing, it is an object of the present invention to provide a single-gamma architecture for a color dynamic analog gamma system that has a simple structure and is well adaptable to existing timing controllers (TCONs).

According to one embodiment, the single-gamma based color gamma generation system includes a gamma controller, a gamma reference voltage generator (GRVG), and an image processor. The gamma controller generates a number of gamma curves associated with a number of colors respectively in a color space (e.g., R, G and B). In a particular embodiment, the gamma controller dynamically generates the gamma curves in accordance with a data distribution of image data. A GRVG generates a plurality of gamma reference voltages according to one selected gamma curve associated with a selected color (e.g., G). An image processor, such as a digital image processor, receives the gamma curves and compensates the image data of a non-selected color or colors (e.g., R and/or B). A source driver receives the plurality of gamma reference voltages generated from the GRVG and receives the compensated image data from the digital image processor. A display panel is then driven by the source driver.

### BRIEF DESCRIPTION OF THE DRAWINGS

FIG. 1A shows a conventional gamma reference voltage generator (GRVG);

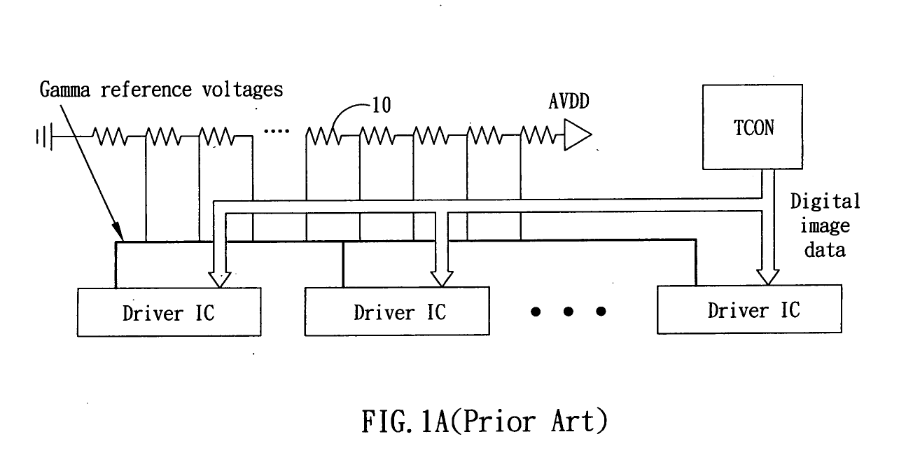

FIG. 1B shows a conventional adaptive analog GRVG;

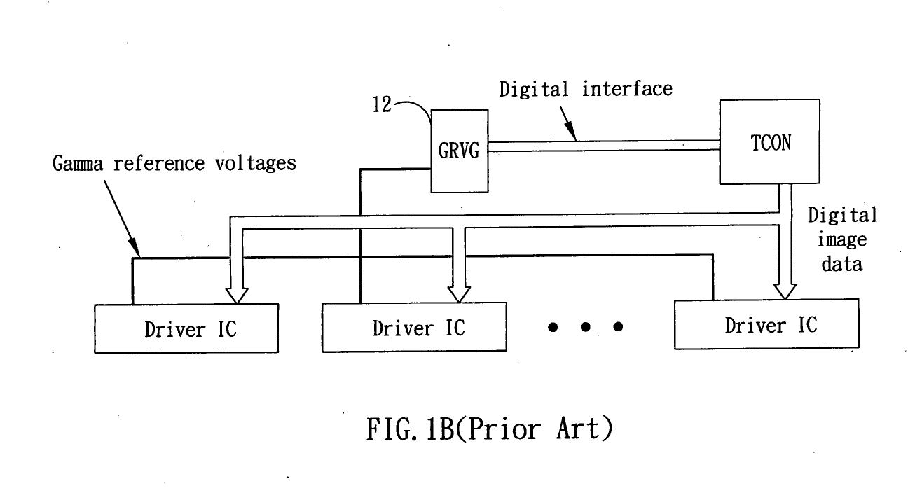

FIG. 2A shows a block diagram of a conventional three-gamma timing controller (TCON);

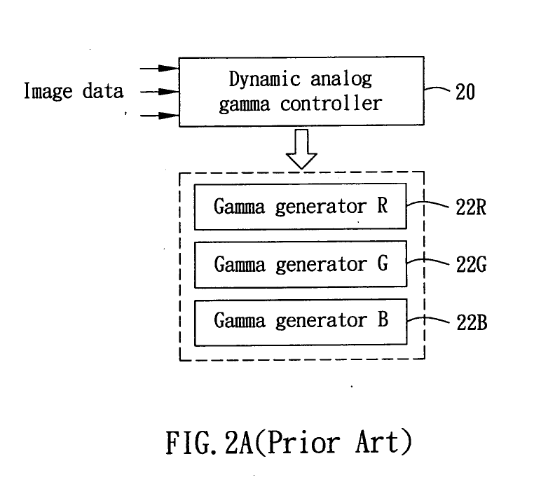

FIG. 2B shows three exemplary independent gamma voltage curves associated with FIG. 2A;

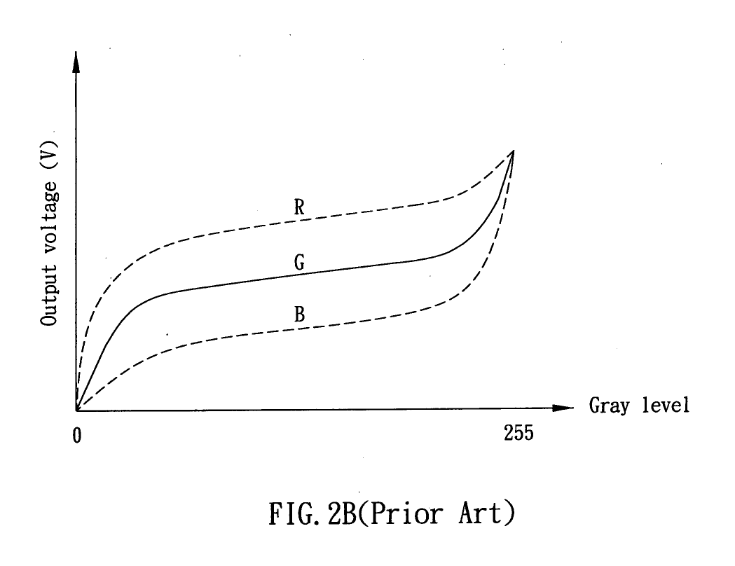

FIG. 3A is a block diagram of a single-gamma based color dynamic gamma generation system according to one embodiment of the present invention;

FIG. 3B shows exemplary gamma curves R, G and B which may accompany the system of FIG. 3A;

FIG. 3C is a flow diagram corresponding to a single-gamma based color dynamic gamma generation method according to one embodiment of the present invention;

FIG. 4A is a histogram exemplifying image data distribution; and

FIG. 4B is a gamma curve before and after the dynamic gamma control (DGC).

### DETAILED DESCRIPTION OF THE INVENTION

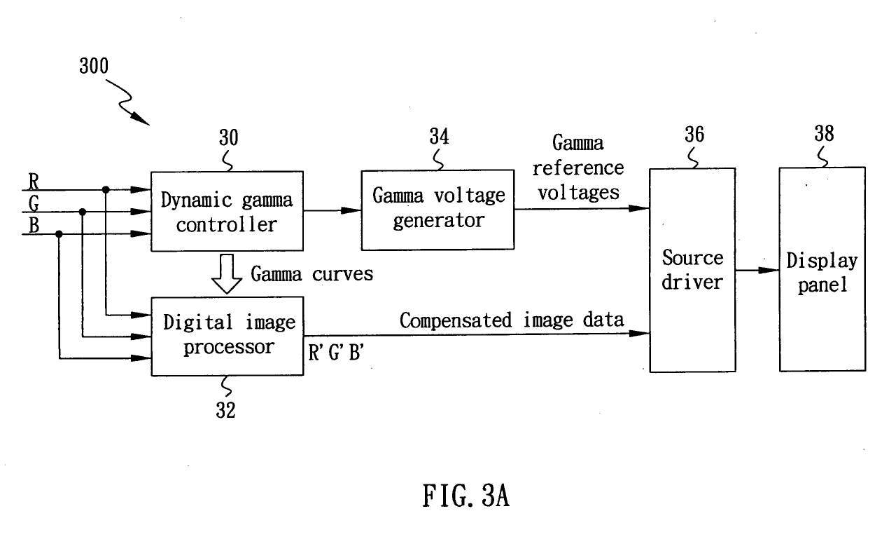

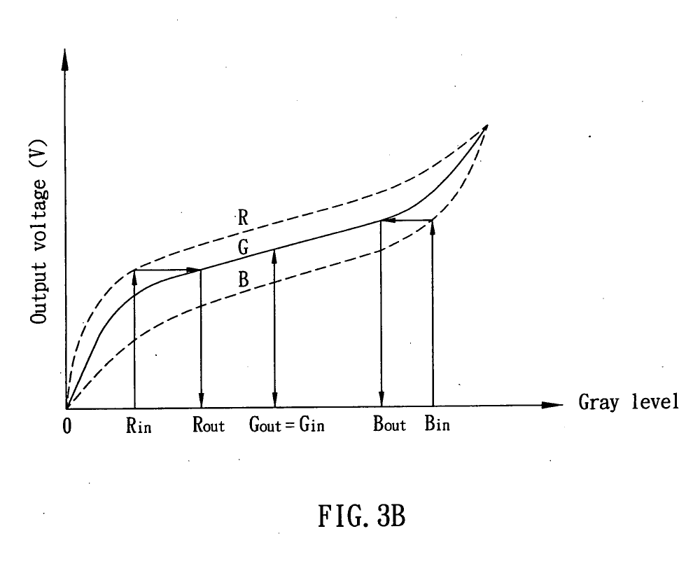

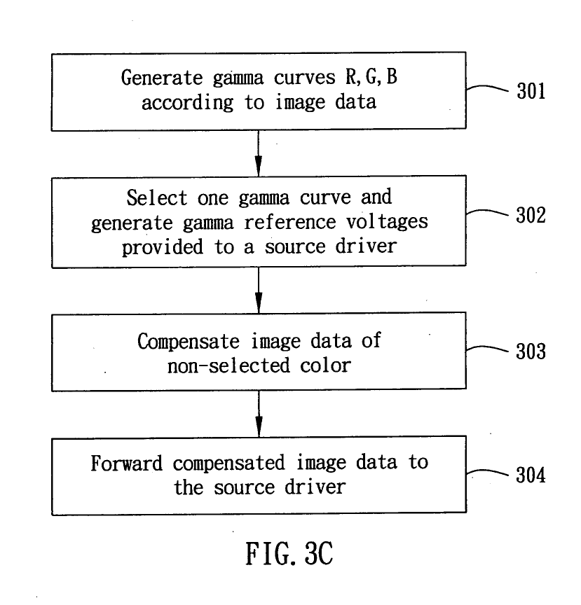

With particular reference to FIG. 3A, a single-gamma based color dynamic gamma generation system 300, according to one embodiment of the present invention, is depicted in block-diagram form to include a dynamic analog gamma controller (“dynamic gamma controller”) 30, a digital image processor 32 and a gamma reference voltage generator (GRVG) 34. FIG. 3B shows exemplary gamma curves R, G and B that may accompany the configuration of FIG. 3A, and FIG. 3C shows a flow diagram corresponding to a single-gamma based color dynamic gamma generation method according to an embodiment of the present invention.

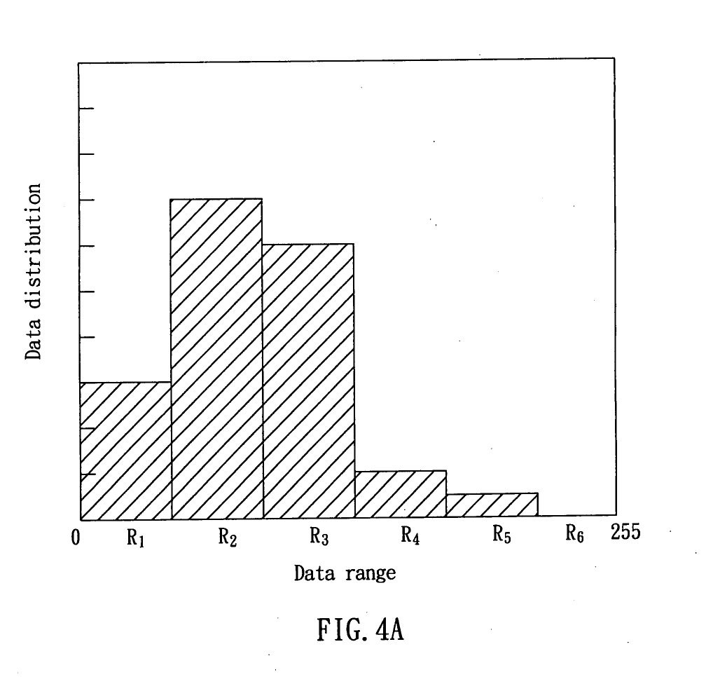

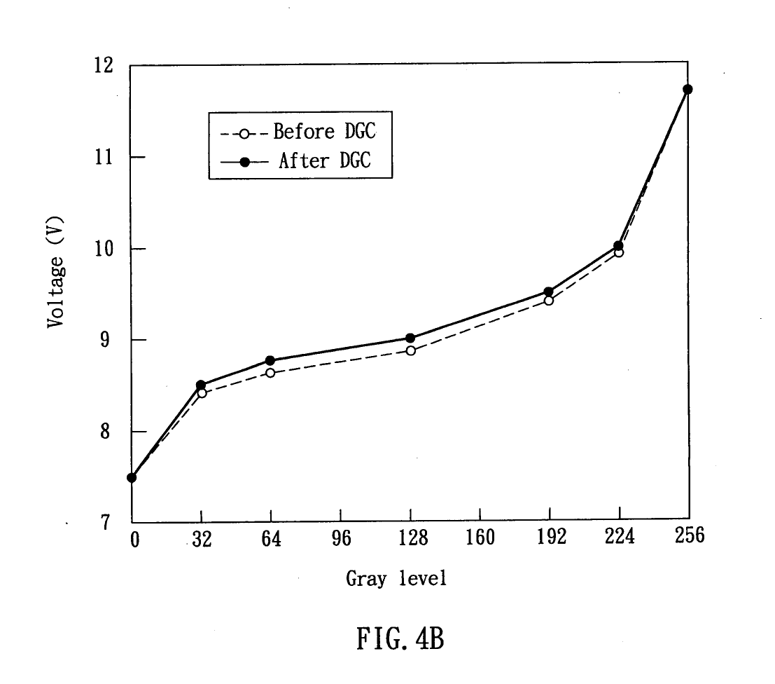

In the exemplary embodiment, the dynamic gamma controller 30 receives image data and, according to a data distribution of the image data, generates gamma curves respectively for a predetermined color space, such as red (R), green (G) and blue (B), as represented by the gamma curves shown in FIG. 3B (step 301). For a specific color, a gray code corresponds to an output voltage. Although the color space R/G/B is used in the embodiment, it is appreciated by those skilled in the art that other color spaces may be adapted in the present invention. The dynamic gamma controller 30 of this embodiment dynamically or adaptively generates the gamma curves in accordance with the data distribution of the image data. For example, as described in the above-referenced Seung-Woo Lee document, one can assume the image to have a data distribution as shown in the histogram of FIG. 4A. As such, with the image having more data in the gray level range R2 (32-63) and R3 (64-127), the gamma curve is thus adjusted more substantially in the ranges R2-R3 than in other ranges, as shown in FIG. 4B. In the embodiment, the dynamic gamma controller 30 dynamically adjusts the gamma curves R, G and B based on the data distribution of the image data R, G and B, respectively. It is noted that only the adjusted gamma curves are shown in FIG. 3B.

Among the three gamma curves R, G and B generated by the dynamic gamma controller 30, only one gamma curve is selected and used as the single gamma curve provided to the GRVG 34 (step 302). The GRVG 34 may include, in one embodiment, a digital-to-analog converter (DAC) that converts data of the digital gamma-curve to analog counterparts. The converted analog gamma reference voltages (“gamma reference voltages”) are then provided to a source driver 36, which drives a display panel 38, such as an LCD. As a variety of architectures of the source driver have been disclosed in the prior art, the specific architecture of the source driver 36 is thus omitted in this specification.

On the other hand, as can be seen in FIG. 3A, the three gamma curves R, G and B from the dynamic gamma controller 30 are also forwarded to the digital image processor 32. As only one gamma curve (for example, curve G) is selected to be the single gamma curve, image data of the other colors (that is, red (R) and blue (B)) should be compensated (step 303) before being inputted to the source driver 36. This compensation may be performed by mapping the data between the selected (G) gamma curve and the non-selected (R and/or B) gamma curve of FIG. 3B. For example, if the input image data R has the value Rᵢₙ, the digital image processor 32 then maps this value to another compensated value R′ having the value of Rₒᵤₜ. In this exemplary case, the output voltage corresponding to the value Rᵢₙ for the non-selected gamma curve R is equal to the output voltage corresponding to the value Rₒᵤₜ for the selected gamma curve G. Similarly, if the input image data B has the value Bᵢₙ, the digital image processor 32 then maps this value to another compensated value B′ having the value of Bₒᵤₜ. In this case, the output voltage corresponding to the value Bᵢₙ for the non-selected gamma curve B is equal to, or approximately equal to, the output voltage corresponding to the value Bₒᵤₜ for the selected gamma curve G. It is appreciated that the image data may be compensated by other methods or algorithms other than that depicted in FIG. 3B and described above. Subsequently, in step 304, the compensated image data R′ and B′ along with the original image data G are inputted to the source driver 36, which further drives the display panel 38. As the image data (e.g., R′ and B′) associated with the non-selected gamma curve have been pre-compensated, they accordingly can be compatible with the selected single gamma curve (e.g., curve G) without inducing distortion.

According to the mentioned embodiments of the present invention, the color dynamic gamma generation system 300 can be configured to utilize a single-gamma architecture, which not only has an architecture substantially simpler than the three-gamma architecture, but is also adaptable to current (e.g., modern) timing controllers.

Although specific embodiments have been illustrated and described, it will be appreciated by those skilled in the art that various modifications may be made without departing from the scope of the present invention, which is intended to be limited solely by the appended claims.

What is claimed is:

1. A single-gamma based color gamma generation system, comprising:
a gamma controller for generating a plurality of gamma curves associated with a plurality of colors respectively in a color space;
a gamma reference voltage generator (GRVG) for generating a plurality of gamma reference voltages according to one selected gamma curve associated with a selected color; and
an image processor for receiving the gamma curves and compensating image data of one or more of the non-selected colors.

2. The system of claim 1, wherein the color space includes red (R), green (G) and blue (B).

3. The system of claim 1, wherein a gray code in the gamma curve corresponds to an output voltage.

4. The system of claim 1, wherein the gamma controller dynamically generates the gamma curves in accordance with a data distribution of the image data.

5. The system of claim 1, wherein the GRVG includes a digital-to-analog converter (DAC).

6. The system of claim 1, wherein the compensated image data from the image processor and the plurality of the gamma reference voltages are forwarded to a source driver.

7. The system of claim 3, wherein the image data are compensated by mapping the image data between the selected gamma curve and the non-selected gamma curve or curves.

8. The system of claim 7, wherein a first image datum in the non-selected gamma curve is mapped to a second image datum in the selected gamma curve, such that the output voltage corresponding to the first image datum in the non-selected gamma curve is approximately equal to the output voltage corresponding to the second image datum in the selected gamma curve.

9. A single-gamma based color gamma generation method, comprising:
generating a plurality of gamma curves associated with a plurality of colors respectively in a color space;
selecting one gamma curve associated with a selected color;
generating a plurality of gamma reference voltages according to the selected gamma curve; and
compensating image data of non-selected color or colors.

10. The method of claim 9, wherein the color space includes red (R), green (G) and blue (B).

11. The method of claim 9, wherein a gray code in the gamma curve corresponds to an output voltage.

12. The method of claim 9, wherein the gamma curves are generated in accordance with a data distribution of the image data.

13. The method of claim 9, further comprising a step of forwarding the compensated image data and the plurality of the gamma reference voltages to a source driver.

14. The method of claim 11, wherein the image data are compensated by mapping the image data between the selected gamma curve and the non-selected gamma curve or curves.

15. The method of claim 14, wherein a first image datum in the non-selected gamma curve is mapped to a second image datum in the selected gamma curve, such that the output voltage corresponding to the first image datum in the non-selected gamma curve is approximately equal to the output voltage corresponding to the second image datum in the selected gamma curve.

16. A single-gamma based display system, comprising:
a dynamic gamma controller for dynamically generating a plurality of gamma curves associated with a plurality of colors respectively in a color space in accordance with data distribution of image data, wherein a gray code in the gamma curve corresponds to an output voltage;
a gamma reference voltage generator (GRVG) for generating a plurality of gamma reference voltages according to one selected gamma curve associated with a selected color;
a digital image processor for receiving the gamma curves and compensating the image data of non-selected color or colors;
a source driver coupled to receive the plurality of the gamma reference voltages generated from the GRVG and to receive the compensated image data from the digital image processor; and
a display panel driven by the source driver.

17. The display system of claim 16, wherein the color space includes red (R), green (G) and blue (B).

18. The display system of claim 16, wherein the image data are compensated by mapping the image data between the selected gamma curve and the non-selected gamma curve or curves.

19. The display system of claim 18, wherein a first image datum in the non-selected gamma curve is mapped to a second image datum in the selected gamma curve, such that the output voltage corresponding to the first image datum in the non-selected gamma curve is approximately equal to the output voltage corresponding to the second image datum in the selected gamma curve.
